(19) United States
(12) Patent Application Publication
(10) Pub. No.: US 2026/0048365 A1
(43) Pub. Date: Feb. 19, 2026

(54) COMPRESSED AIR FOAM MIXING SYSTEM

(71) Applicant: Zeco, LLC, Chattanooga, TN (US)

(72) Inventor: Kyle B. Johnson, Booneville, IA (US)

(21) Appl. No.: 19/369,005

(22) Filed: Oct. 24, 2025

Related U.S. Application Data
(63) Continuation of application No. 17/412,545, filed on Aug. 26, 2021, now Pat. No. 12,453,943.
Application No. 17/412,545 is a continuation-in-part of application No. 16/210,152, filed on Dec. 5, 2018, now abandoned.

(51) Int. Cl. B01F 23/235; B01F 23/232; B01F 25/31; B01F 35/71; B05B 7/00

(52) U.S. Cl. CPC B01F 23/235; B01F 23/2323; B01F 25/3111; B01F 35/71745; B05B 7/0025

(57) ABSTRACT

A compressed air foam mixing system that has a mixing device connected to a discharge port of a tank. The mixing device receives fluid from the tank and pressurized air from the tank or alternatively directly from a source of pressurized air. The fluid and pressurized air are combined within the mixing device to form a foam.

### CROSS REFERENCE TO RELATED APPLICATION

This application is a continuation of U.S. application Ser. No. 17/412,545 filed Aug. 26, 2021, which is a continuation-in-part of U.S. Ser. No. 16/210,152 filed Dec. 5, 2018, the contents of this application is hereby incorporated by reference in its entirety.

### BACKGROUND OF THE INVENTION

The present invention is directed to a compressed air foam mixing system and more particularly a system for producing antibacterial or biodecontaminant foam to kill molds, yeast and the like.

Compressed air foam systems are known in the art. Generally, these devices are used to produce foam to combat fires. A typical system includes a foam injector system, a water pump system, and an air system including an air compressor for supplying air under pressure. While useful, these systems are complex in their design, have many parts, and are expensive to produce. Accordingly, a need exists in the art for a system that addresses these deficiencies.

An objective of the present invention is to provide a compressed air foam system that has a simple design and is inexpensive to manufacture.

These and other objectives will be apparent to those having ordinary skill in the art based upon the following written desc ription, drawings, and claims.

### SUMMARY OF THE INVENTION

A compressed air foam mixing system includes a mixing device connected to a discharge port of a tank that contains a fluid. The mixing device has a hollow, elongated body with a first end, a second end, and a side wall. The first end has an end wall that surrounds a central opening. The central opening aligns with a central bore that extends from the first end of the elongated body to a mixing chamber and the mixing chamber extends from the central bore to the second end of the elongated body.

The central bore is formed by an inner wall that extends from the first end of an elongated body to a shoulder that is preferably angled. The end wall has a plurality of apertures that surround the central opening. The apertures are aligned and in communication with a plurality of bores that extend through the inner wall and preferably are angled toward, and in communication with, the central bore.

A pick-up tube is connected to the central bore of the mixing device and extends from the mixing device to the bottom of the tank. The pick-up tube supplies fluid, under pressure, to the mixing chamber of the mixing device. Pressurized air is supplied to the mixing chamber either from the tank through the bores that surround the central bore or directly from a source of pressurized air through an air port in the side wall of the mixing device.

### BRIEF DESCRIPTION OF THE DRAWINGS

FIG. 1 is a top perspective view of a mixing device;

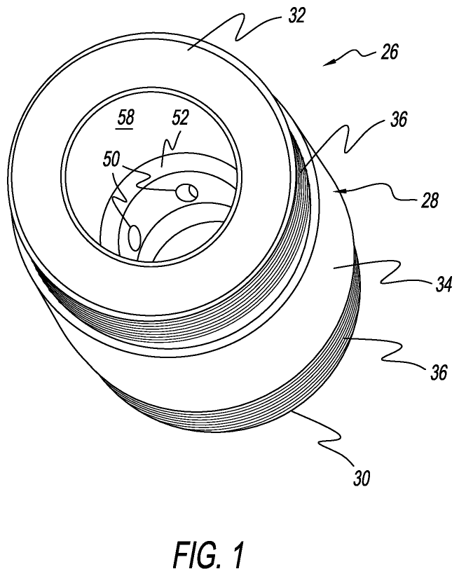

FIG. 2 is a bottom perspective view of a mixing device;

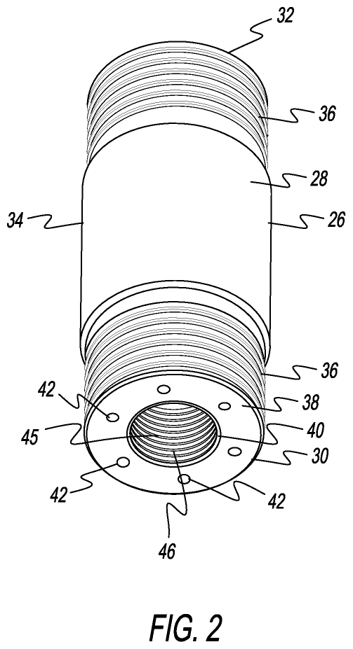

FIG. 3 is a side sectional view of a mixing device;

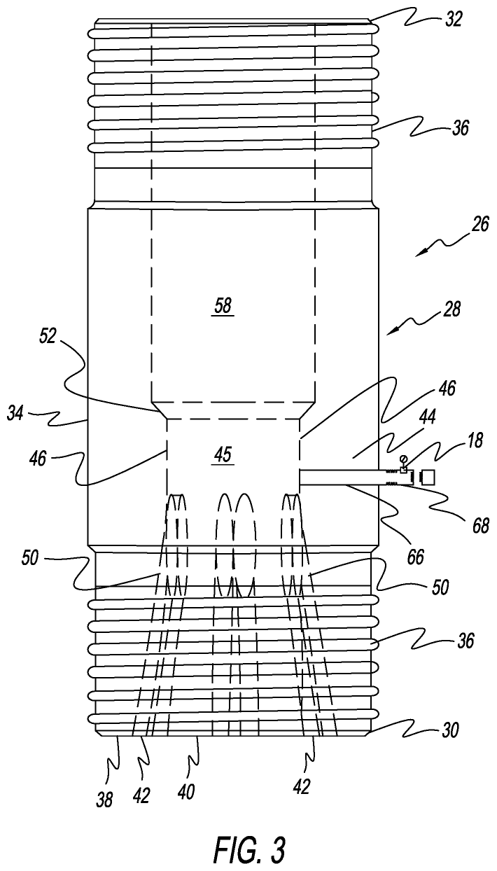

FIG. 4 is a side sectional view of a compressed air foam mixing system; and

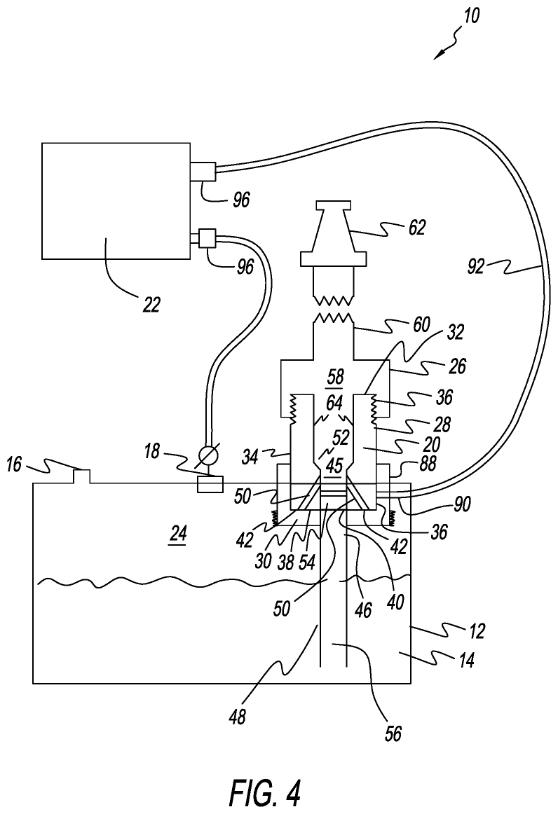

FIG. 5 is a side sectional view of a compressed air foam mixing system.

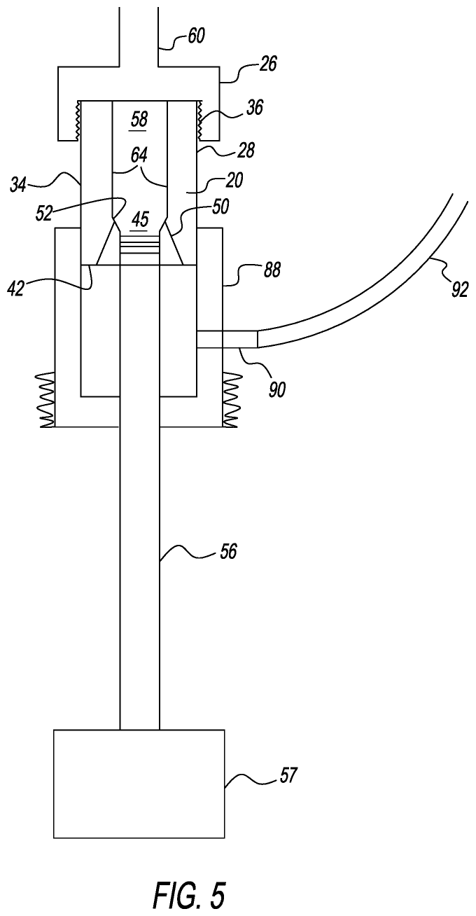

### DETAILED DESCRIPTION

Referring to the Figures, a compressed air foam mixing system 10 includes a tank 12 filled with fluid 14. Preferably, the fluid 14 is an antibacterial or biodecontaminant for killing molds, yeast, and the like. The tank 12 has an air port 16, an air pump valve 18, and a threaded discharge port 20. The air pump valve 18 is connected to a source of pressurized air 22 and provides pressurized air 24 to the tank.

A mixing device 26 is threadably connected to the discharge port 20. While the mixing device 26 is of any size, shape, and structure, in one example, the mixing device 26 has an elongated, hollow, cylindrical body 28 having a first end 30, a second end 32, and a side wall 34. Adjacent each end 30 and 32, an outer surface 36 of the side wall 34 is threaded.

The first or lower end 30 of the mixing device 26 has an end wall 38 that surrounds a central opening 40. The end wall 38 has a plurality of apertures 42 that surround the central opening 40. Extending from the end wall 38, into the hollow body 28, is a partial inner wall 44 that is adjacent the central opening 40 to form a central bore 45. An inner surface 46 of the central bore 45 is threaded to threadably receive a pick-up tube 48. A plurality of bores 50 extend from, and are in alignment with, the apertures 42. Bores 50 extend from the apertures 42 to an inner shoulder 52 that is formed by the termination of the inner wall 44. Preferably, the shoulder 52 is angled outwardly from the central bore 45 and upwardly toward the second end 32. Alternatively, the bores 50 are angled upwardly, and inwardly, and are in communication with the central bore 45.

The pick-up tube 48 has a threaded head 54 and is connected to, and in communication with, an elongated conduit or hose 56. The threaded head 54 is connected to the inner surface 46 of the central bore 45. The hose 56 extends from the head 54 to the bottom of the tank 12.

The central bore 45 and the plurality of bores 50 are in communication with a mixing chamber 58. The mixing chamber 58 extends from the shoulder 52 of the inner wall 44 to the second end 32 of the elongated body 28. A hose 56 having a nozzle 62 is threadably attached to the threaded outer surface 36 of the second end 32.

In operation, pressurized air 24 is supplied to the tank 12 from the source of pressurized air 22 through the air pump valve 18. When the nozzle 62 is activated and opened the pressurized air 24 flows through the plurality of bores 50 and into the mixing chamber 58. The pressurized air 24 also acts upon the fluid 14 causing the fluid 14 to flow through the pick-up tube 48, into the central bore 45, and finally into the mixing chamber 58. The diameter of bores 50 preferably ⅛ inches, the diameter of the central bore 45 preferably ¾ inches, and the diameter of the mixing chamber 58 preferably ⅞ inches, causes the pressurized air 24 to mix with the fluid 14 to create a foam 64. The foam 64 flows from the mixing chamber 50, through the hose 56, and out the nozzle 62.

In an alternative embodiment connected to the end of the hose 56 is a check valve 57. The hose 56 extends from the check valve 57 through the mixing device 100 to the output 60. The mixing device 26 is connected to and in communication with the output 60. The mixing device includes a top 27 threadably connected to a cylindrical body 28 as previously described. The cylindrical body 28 is threadably connected to an air manifold 88 that is sealed about hose 56. The air manifold 88 has an air port 90. The air port 90 is connected to a source of pressurized air 22 by line 92. The pressurized air 22 is controlled by a control system 94. The pressurized air 22 has check valves 96 that lead to air port 90 and pump valve 18. As a result a pressure differential is created between the air provided to the mixing device 26 and the air tank 12. This allows the pressures to be adjusted to fine tune the consistency of the foam between wet and dry. The tank pressure 12 affects how far the foam sprays while the air supplied to the air manifold 66 affects the foam consistency.

From the above discussion and accompanying figures and claims it will be appreciated that a compressed air foam mixing system 10 offers many advantages over the prior art. It will be appreciated further by those skilled in the art that various other modifications could be made to the device without parting from the spirit and scope of this invention. All such modifications and changes fall within the scope of the claims and are intended to be covered thereby. It should be understood that the examples and embodiments described herein are for illustrative purposes only and that various modifications or changes in the light thereof will be suggested to persons skilled in the art and are to be included in the spirit and purview of this application.

1. (canceled)

2. A compressed air foam mixing system, comprising:
a tank at least partially filled with a pressurized fluid comprising a pressurized liquid portion and the tank having a discharge port;
a mixing device having a hollow elongated body configured to receive a first input flow of a pressurized air and a second input flow of the pressurized liquid portion, the mixing device comprising:
a first end comprising a first end wall surrounding a first central opening;
a second end comprising a second end wall surrounding a second central opening;
a side wall extending between the first and second end wall;
a partial inner wall extending from the first end wall towards the second end wall that terminates at an intermediate location between the first and second end walls defining an inner shoulder, and the partial inner wall defining a central bore having a first diameter extending from the first central opening of the first end wall to proximate the inner shoulder, wherein the central bore configured to be in fluid communication with the second input flow of the pressurized liquid portion via the discharge port of the tank;
a plurality of bores extending from a plurality of outer apertures surrounding the first central opening at the first end wall through at least a portion of the side wall to a plurality of inner apertures located at the partial inner wall of the central bore, such that each of the plurality of outer apertures are in fluid communication with the central bore via a corresponding inner aperture and respective bore, and wherein each of the plurality of bores are configured to be in fluid communication with the first input flow of pressurized air; and
a mixing chamber having second diameter extending from the second central opening of the second end wall to proximate the inner shoulder, whereby the second diameter of the mixing chamber is greater than the first diameter of the central bore;
wherein the first end wall is in a perpendicular configuration to each of the first input flow of pressurized air entering into the plurality of bores and the second input flow of the pressurized liquid portion entering into the central bore, and the mixing chamber is configured to receive the first input flow of pressurized air via the plurality of bores and the second input flow of the pressurized liquid portion via the central bore, such that the mixing chamber is configured to mix the first input flow of pressurized air and the second flow of the pressurized liquid portion to form a foam; and
an output assembly operably connected with the mixing chamber and configured to discharge a flow of the foam from the mixing chamber.

3. The compressed air foam mixing system of claim 2, wherein the pressurized fluid contained within the tank further comprising a pressurized air portion.

4. The compressed air foam mixing system of claim 3, further comprising a source of pressurized air in fluid communication with the tank to provide the pressurized fluid within the tank.

5. The compressed air foam mixing system of claim 4, further comprising an air manifold connected between the mixing device and the discharge port, wherein the air manifold is configured to receive the first input flow of pressurized air from the source of pressurized air and provide the first input flow of pressurized air to each of the plurality of bores.

6. The compressed air foam mixing system of claim 5, further comprising a pick-up tube operably connected to the central bore, wherein the pick-up tube having an elongated hose configured to receive the second input flow of the pressurized liquid portion from tank and provide the second input flow of the pressurized liquid portion to the central bore.

7. The compressed air foam mixing system of claim 6, wherein the air manifold is sealed about the elongated tube.

8. The compressed air foam mixing system of claim 6, wherein the pick-up tube having a threaded head configured to operably connect with a threaded portion of the partial inner wall of the central bore.

9. The compressed air foam mixing system of claim 5, further comprising a first air pump valve connected between the source of pressurized air and the tank, and wherein the first air pump valve is adapted to provide the pressurized air portion within the tank.

10. The compressed air foam mixing system of claim 9, further comprising a second air pump valve connected between the source of pressurized air and an air port in a side wall of the air manifold, and wherein the second air pump valve is adapted to provide the first input flow of pressurized air to the mixing device.

11. The compressed air foam mixing system of claim 10, wherein the air port is in fluid communication with the source of pressurized air by a line.

12. The compressed air foam mixing system of claim 5, wherein the mixing device is threadedly connected to the air manifold.

13. The compressed air foam mixing system of claim 4, further comprising a control system, wherein the source of pressurized air is configured to be controlled by the control system to create a pressure differential between the first input flow of pressurize air and the second input flow of pressurized liquid, such that the source of pressurized air provided to the air manifold affects the flow of pressurized air into the mixing chamber and foam consistency between wet and dry.

14. The compressed air foam mixing system of claim 13, wherein a tank pressure within the tank affects the second input flow of the pressurized liquid portion into the mixing chamber and how far the foam can be sprayed.

15. The compressed air foam mixing system of claim 16, wherein the source of pressurized air provided to the mixing device affects the first input flow of pressurized air into the mixing chamber and the foam consistency.

16. The compressed air foam mixing system of claim 16, wherein the control system is configured to control the pressure differential to adjust foam consistency, foam velocity discharged from the output assembly, or a combination thereof.

17. The compressed air foam mixing system of claim 16, wherein the output assembly having a hose and a nozzle, the hose connected to the second end of the mixing device at one end and the nozzle at an opposite end of the hose.

18. The compressed air foam mixing system of claim 17, wherein the nozzle of the output assembly is configured to activate each of the first input flow of pressurized air and the second input flow of pressurized liquid portion into the mixing chamber to form the foam.

19. The compressed air foam mixing system of claim 2, wherein the pressurized liquid portion of the pressurized fluid comprises an antibacterial or biodecontaminant.

20. The compressed air foam mixing system of claim 2, wherein the second end wall is configured to be perpendicular to the flow of foam being discharged from the mixing chamber.

21. The compressed air foam mixing system of claim 2, wherein the first end wall is in an opposing parallel configuration with the second end wall.

22. The compressed air foam mixing system of claim 2, wherein each of the plurality of bores has a smaller diameter than the central bore.

23. The compressed air foam mixing system of claim 2, wherein the inner shoulder is configured to be angled outwardly from the central bore and upwardly toward the second end of the hollow elongated body.
